(19) United States
(12) Patent Application Publication
(10) Pub. No.: US 2020/0118075 A1
(43) Pub. Date: Apr. 16, 2020

(54) METHOD AND APPARATUS FOR DIVIDING DELIVERY REGIONS, ELECTRONIC DEVICE, AND COMPUTER-READABLE STORAGE MEDIUM

(71) Applicant: BEIJING XIAODU INFORMATION TECHNOLOGY CO., LTD., Beijing (CN)

(72) Inventors: Qiuyuan YANG, BEIJING (CN); Mingquan XU, BEIJING (CN); Shaojian HUANG, BEIJING (CN); Ke XIAN, BEIJING (CN); Jinqing CHEN, BEIJING (CN); Jiajia RAO, BEIJING (CN)

(21) Appl. No.: 16/713,318

(22) Filed: Dec. 13, 2019

Related U.S. Application Data
(63) Continuation of application No. PCT/CN2017/109999, filed on Nov. 8, 2017.

(30) Foreign Application Priority Data
Jun. 14, 2017 (CN) 201710449213.6

(51) Int. Cl. G06Q 10/08; G06K 9/62

(52) U.S. Cl. CPC G06Q 10/0838; G06K 9/6218; G06K 9/6215

(57) ABSTRACT

A delivery area division method and apparatus, an electronic device, and a computer-readable storage medium are disclosed. The method includes: performing clustering process on a plurality of historical orders based on similarities between geographical locations of the plurality of historical orders to obtain N class clusters; obtaining, based on the geographical location of each of one or more historical orders in each of the N class clusters, a coverage area for each of the N class clusters; and determining, based on the coverage areas, a delivery area corresponding to each of the N class clusters. Coverage areas of different class clusters can be relatively independent of each other by using the foregoing clustering process. Therefore, automatic division of delivery areas is performed based on clustering process for geographical locations of a large quantity of historical orders, and the number cross-area orders can be reduced.

### CROSS-REFERENCE TO RELATED APPLICATION

This application is a continuation application of International Patent Application No. PCT/CN2017/109999, filed on Nov. 8, 2017, which is based on and claims priority to the Chinese Patent Application No. 201710449213.6, filed on Jun. 14, 2017 and entitled “METHOD AND APPARATUS FOR DIVIDING DELIVERY REGIONS, ELECTRONIC DEVICE, AND COMPUTER-READABLE STORAGE MEDIUM.” The above-referenced applications are incorporated herein by reference in their entirety.

### TECHNICAL FIELD

This disclosure relates to the field of Internet technologies, and more specifically, to a delivery area division method and apparatus, an electronic device, and a computer-readable storage medium.

### BACKGROUND

With the development of the Internet technologies, Online To Offline (O2O) service, as a novel service mode, has greatly changed people's life. For example, in terms of shopping, users can order desirable items with online shopping applications without leaving his/her home. However, these applications, while bringing convenience to users, face the problem of efficiently scheduling order delivery. Accordingly, logistics scheduling systems are developed.

Currently, in some scenarios such as a same-city delivery, the orders are usually scheduled based on delivery areas (also referred to as business districts in some scenarios) in a logistics scheduling system. In short, the orders generated in a delivery area are allocated to delivery persons belonging to the delivery area.

### SUMMARY

Currently, the division of delivery areas in a city is conducted on the map based on related personnel's knowledge of the city's urban traffic condition, merchant distribution, user distribution, etc. A city may be divided into a plurality of delivery areas that are not intersected with each other. That is, an order in the city is scheduled based on a plurality of manually-divided delivery areas.

The delivery area divided based on experience may be improper, which may lead to a waste of a delivery capacity during order scheduling.

For example, a large quantity of cross-area orders may be generated based on the delivery areas divided based on personal experience. In a conventional delivery area-based order scheduling mechanism, these cross-area orders cause an empty-loaded return of a delivery person, which leads to a waste of a delivery capacity.

In a take-out order delivery scenario, the order may include two types of location information: a pickup location and a delivery location. In this case, when a pickup location and a delivery location of an order correspond to different delivery areas, the order is a cross-area order.

In the foregoing delivery area-based order scheduling mechanism, a delivery person can only accept orders having a delivery area to which the delivery person belongs. A delivery area of an order may be determined based on a delivery area corresponding to a pickup location of the order. When the order is being scheduled, the order needs to be allocated to a delivery person belonging to delivery area A for delivery. A delivery area to which a delivery person belongs may be determined based on registration information provided by the delivery person (e.g., a specific delivery area the delivery person registers) in the logistics scheduling system. That is, assuming a delivery person belongs to delivery area A, that delivery person can only accept orders in delivery area A (i.e., the delivery person can only accept orders whose pickup locations are in delivery area A).

The aforementioned empty-loaded return issue may be understood based on the following example. Assuming a cross-area order has a pick location in delivery area A, and a delivery location in delivery area B. The order will be determined as an order of delivery area A and will be allocated to a delivery person in delivery area A for delivery. After the delivery person completes the delivery at the delivery location in delivery area B, the empty-unloaded delivery person needs to return to the home delivery area A to continue to accept another order of delivery area A, and cannot accept an order of delivery area B in delivery area B. This is because the delivery person, belonging to delivery area A, can only accept the order of delivery area A. Consequently, the cross-area order causes an empty-loaded return of the delivery person to delivery area A, thereby wasting the delivery capability.

Therefore, due to limited experience and consideration factor, the foregoing delivery area division may be improper, which may adversely affect the delivery capacity.

In view of this, this disclosure provides a delivery area division method and apparatus, an electronic device, and a computer-readable storage medium that address the aforementioned deficiencies.

A first aspect of this disclosure is directed to a delivery area division method. The method may include: performing clustering process on a plurality of historical orders based on similarities between geographical locations of the plurality of historical orders to obtain N class clusters, where N≥1, and the geographical location comprises a pickup location and a delivery location; obtaining, based on the geographical location of each of one or more historical orders included in each of the N class clusters, a coverage area corresponding to each of the N class clusters; determining, based on the coverage area corresponding to each of the N class clusters, a delivery area corresponding to each of the N class clusters; and determining, based on an original cross-area order ratio and a new cross-area order ratio, whether the delivery area corresponding to each of the N class clusters is proper, and, in response to the delivery area corresponding to one of the N class clusters being determined to be improper, replacing the delivery area by an original delivery area corresponding to the one of the N class cluster.

The original cross-area order ratio may be determined based on original delivery areas respectively corresponding to the plurality of historical orders, and the new cross-area order ratio may be determined based on the delivery area corresponding to each of the N class clusters.

Determining, based on the coverage area corresponding to each of the N class clusters, a delivery area corresponding to each of the N class clusters may include: for any class cluster Ni in the N class clusters, if the coverage area corresponding to the class cluster Ni overlaps with the coverage area corresponding to another class cluster Nj, determining a quantity of order line segments corresponding to each of the class cluster Ni and the class cluster Nj in an overlapping area between the class cluster Ni and the class cluster Nj, wherein j=1, 2, . . . , N, and j≠i; obtaining an adjusted coverage area corresponding to the class cluster Ni by allocating the overlapping area between the class cluster Ni and the class cluster Nj to the class cluster that has the largest quantity of order line segments in the overlapping area; and determining the delivery area corresponding to the class cluster Ni to be the adjusted coverage area corresponding to the class cluster Ni.

A second aspect of this disclosure is directed to a delivery area division apparatus. The apparatus may include a clustering module, an obtaining module, and a first determining module.

The clustering module may be configured to perform clustering process on a plurality of historical orders based on similarities between geographical locations of the plurality of historical orders to obtain N class clusters. N≥1, and the geographical location may include a pickup location and a delivery location. The obtaining module may be configured to obtain, based on the geographical location of each of one or more historical orders included in each of the N class clusters, a coverage area corresponding to each of the N class clusters. The first determining module may be configured to determine, based on the coverage area corresponding to each of the N class clusters, a delivery area corresponding to each of the N class clusters, and determine, based on an original cross-area order ratio and a new cross-area order ratio, whether the delivery area corresponding to each of the N class clusters is proper, and, in response to the delivery area corresponding to one of the N class clusters being determined to be improper, replace the delivery area by an original delivery area corresponding to the one of the N class cluster.

The original cross-area order ratio may be determined based on original delivery areas respectively corresponding to the plurality of historical orders, and the new cross-area order ratio may be determined based on the delivery area corresponding to each of the N class clusters.

Determining, based on the coverage area corresponding to each of the N class clusters, a delivery area corresponding to each of the N class clusters may include: for any class cluster Ni in the N class clusters, if the coverage area corresponding to the class cluster Ni overlaps with the coverage area corresponding to another class cluster Nj, determining a quantity of order line segments corresponding to each of the class cluster Ni and the class cluster Nj in an overlapping area between the class cluster Ni and the class cluster Nj, wherein j=1, 2, . . . , N, and j≠i; obtaining an adjusted coverage area corresponding to the class cluster Ni by allocating the overlapping area between the class cluster Ni and the class cluster Nj to the class cluster that has the largest quantity of order line segments in the overlapping area; and determining the delivery area corresponding to the class cluster Ni to be the adjusted coverage area corresponding to the class cluster Ni.

In some embodiments, the delivery area division apparatus may include a processor and a memory, the memory may be configured to store a program that supports the delivery area division apparatus in performing the delivery area division method in the first aspect, and the processor may be configured to execute the program stored in the memory. The delivery area division apparatus may further include a communications interface, configured to communicate with another device or a communications network by the delivery area division apparatus.

A third aspect of this disclosure is directed to a computer-readable storage medium, configured to store a computer software instruction used by a delivery area division apparatus, and the computer software instruction may include a program used to perform the delivery area division method in the first aspect.

According to the delivery area division method and apparatus, the electronic device, and the computer-readable storage medium provided in this disclosure, a large quantity of real historical orders are obtained. Based on similarities between geographical locations of these historical orders, clustering process may be performed on these historical orders, and historical orders whose geographical locations are closer may be clustered into one class cluster, so as to obtain N class clusters. Further, for any class cluster, based on distribution of geographical locations of one or more historical orders included in the class cluster, a closed coverage area including geographical locations of all historical orders in the class cluster may be obtained, and a delivery area corresponding to the class cluster may be determined based on the coverage area. Because historical orders belonging to a same class cluster have high geographical location similarities, and historical orders in different class clusters have low geographical location similarities, by using the foregoing clustering process, coverage areas of different class clusters may be relatively independent of each other. Therefore, automatic division of delivery areas is implemented based on clustering process for geographical locations of a large quantity of historical orders.

In addition, this solution may also be understood as a process of continuously optimizing each delivery area. Each delivery area that already exists before this division method is performed may be referred to as an original delivery area. For the foregoing historical orders, some of these historical orders may be cross-area orders based on geographical locations of the historical orders in the original delivery areas. After being processed using the delivery area division method of this disclosure, the historical order that is previously a cross-area order may be clustered into one class cluster based on a geographical location similarity with another historical order, and a coverage area of the class cluster may include a geographical location of the cross-area historical order. Therefore, a delivery area obtained based on the coverage area of the class cluster may cover the geographical location of the cross-area historical order. Then, a new order corresponding to the geographical location of the cross-area historical order is no longer a cross-area order if it is received subsequently. Therefore, by continuously optimizing the division of the delivery areas based on this solution, the number of cross-area orders may be effectively reduced.

### BRIEF DESCRIPTION OF THE DRAWINGS

To describe the technical solutions in the embodiments of the disclosure or in the prior art more clearly, the following briefly introduces the accompanying drawings required for describing the embodiments or the prior art. Apparently, the accompanying drawings in the following description show some embodiments of the disclosure, and a person of ordinary skill in the art may still derive other drawings from these accompanying drawings without creative efforts.

FIG. 1 is a flowchart illustrating Embodiment 1 of a delivery area division method of this disclosure.

FIG. 2 is a flowchart illustrating an implementation of step 102 in the embodiment shown in FIG. 1.

FIG. 3a is a flowchart illustrating an implementation of step 103 in the embodiment shown in FIG. 1.

FIGS. 3b, 3c, 3d, 3e, and 3f are schematic diagrams illustrating the execution of the embodiment shown in FIG. 3a.

FIG. 4 is a flowchart illustrating Embodiment 2 of a delivery area division method of this disclosure.

FIG. 5 is a schematic structural diagram illustrating Embodiment 1 of a delivery area division apparatus of this disclosure.

FIG. 6 is a schematic structural diagram illustrating Embodiment 2 of a delivery area division apparatus of this disclosure.

FIG. 7 is a schematic structural diagram illustrating Embodiment 3 of a delivery area division apparatus of this disclosure.

FIG. 8 is a schematic structural diagram illustrating Embodiment 4 of a delivery area division apparatus of this disclosure.

FIG. 9 is a schematic structural diagram illustrating an electronic device corresponding to a delivery area division apparatus according to an embodiment of this disclosure.

### DETAIL DESCRIPTION OF THE EMBODIMENTS

To make the objectives, technical solutions, and advantages of embodiments of this disclosure clearer, the following gives a clear description of technical solutions in the embodiments of this disclosure in full with reference to accompanying drawings in the embodiments of this disclosure. Apparently, the described embodiments are some but not all of the embodiments of this disclosure. All other embodiments derived by a person of ordinary skill in the art based on the embodiments in this disclosure without creative efforts shall fall within the protection scope of this disclosure.

The terms used in the embodiments of this disclosure are intended merely for describing specific embodiments rather than limiting this disclosure. The terms “a”, “said” and “the” of singular forms used in the embodiments and the appended claims of the disclosure are also intended to include plural forms, unless otherwise specified in the context clearly. “A plurality of” generally includes at least two, but is not intended to exclude a case of at least one.

It should be understood that the term “and/or” in this specification describes only an association relationship for describing associated objects and represents that three relationships may exist. For example, A and/or B may represent the following three cases: Only A exists, both A and B exist, and only B exists. In addition, the character “/” in this specification generally represents an “or” relationship between the associated objects.

It should be understood that, although the terms such as “first”, “second”, and “third” may be used to describe specific items in the embodiments of this disclosure. The specific items, however, shall not be limited by these terms. These terms are merely used to distinguish between the specific items. For example, a first “object” may also be referred to as a second “object” without departing from the scope of the embodiments of this disclosure. Similarly, a second “object” may also be referred to as a first “object”.

Depending on the context, for example, word “if” used herein may be explained as “while” or “when” or “in response to determining” or “in response to detection”. Similarly, depending on the context, phrase “if determining” or “if detecting (a stated condition or event)” may be explained as “when determining” or “in response to determining” or “when detecting (the stated condition or event)” or “in response to detection (the stated condition or event)”.

It should be further noted that the terms “comprise”, “include”, or their any other variant is intended to cover a non-exclusive inclusion, so that a commodity or a system that includes a list of elements not only includes those elements but also includes other elements that are not expressly listed, or further includes elements inherent to such a commodity or system. An element preceded by “includes a . . . ” does not, without more constraints, preclude the existence of additional identical elements in the commodity or the system that includes the element.

It should be further noted that a sequence of steps in the embodiments of the disclosure is adjustable, and the steps are not mandatorily performed according to the following example sequence.

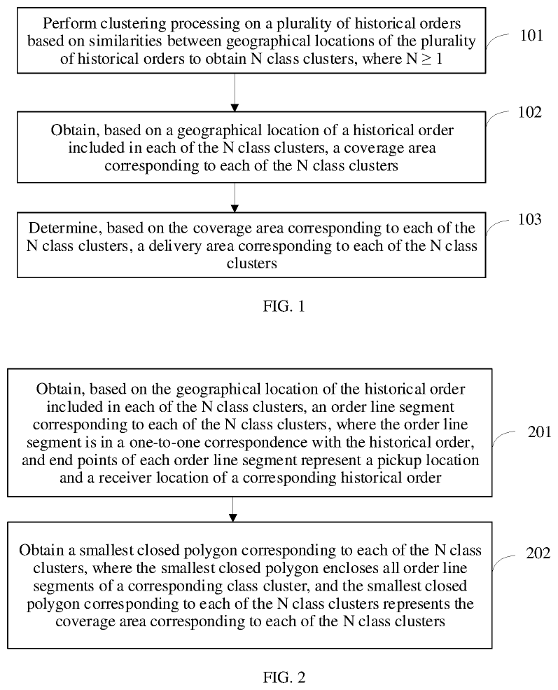

FIG. 1 is a flowchart illustrating Embodiment 1 of a delivery area division method of this disclosure. The delivery area division method provided in this disclosure may be performed by a delivery area division apparatus. The delivery area division apparatus may be implemented as software, or may be implemented as a combination of software and hardware. The delivery area division apparatus may be integrated into a device on a logistics scheduling platform end, such as a server. As shown in FIG. 1, the method may include the following steps.

In step 101, clustering process may be performed on a plurality of historical orders based on similarities between geographical locations of the plurality of historical orders to obtain N class clusters, where N≥1.

The plurality of historical orders may be obtained by collecting orders corresponding to one or more original delivery areas of a city within a certain historical time period. The original delivery area may be a delivery area that has been divided before the delivery area division method of this disclosure is performed. From this perspective, the delivery area division method of this disclosure may also be considered as an optimization method for delivery area division.

In one scenario, a specific requirement may be to re-draw one or more original delivery areas in a city. Based on a rule for determining a delivery area to which an order belongs (e.g., determining a delivery area an order belongs to according to a pickup location of the order), all or some of historical orders corresponding to the one or more original delivery areas may be selected from all historical orders received within a specific historical time period as the plurality of historical orders.

For a delivery order, a geographical location corresponding to an order may include a pickup location and a delivery location. In a take-out order scenario, the pickup location may usually correspond to an address of a merchant, and the delivery location may usually correspond to an address of a user who places the order.

In some embodiments, the similarity between geographical locations of historical orders, based on which clustering process is performed on the plurality of historical orders, may be measured based on at least one of the following parameters: a distance between pickup locations, a distance between delivery locations, or a distance between a center point of the pickup locations and a center point of the delivery locations.

In some embodiments, clustering process may be performed on a plurality of historical orders in the following manner. A similarity threshold may first be preset, and a geographical location similarity between any two historical orders may be calculated, so that historical orders whose geographical location similarity is greater than or equal to the similarity threshold are clustered into a same class cluster.

More specifically, in some embodiments, a historical order may first be selected from a plurality of historical orders as a reference order, and a class cluster may be derived from the reference order. Further, based on a geographical location similarity between a remaining unclustered historical order and the reference order, a historical order whose geographical location similarity with the reference order is greater than the similarity threshold may be selected from the remaining unclustered historical order, and added to the class cluster corresponding to the reference order, so as to form the class cluster corresponding to the reference order. Herein, an unclustered historical order is a historical order that has not been clustered into a class cluster. Then, for remaining unclustered historical orders, similar processes, including selecting a reference order and forming a class cluster corresponding to the reference order, may be repeated until all the historical orders are clustered into a class cluster.

For example, assuming that the plurality of historical orders include order 1, order 2, order 3, order 4, order 5, and order 6. A reference order selected for the first time may be order 1, and class cluster 1 may be derived. A geographical location similarity between order 1 and each of other unclustered historical orders (i.e., order 2, order 3, order 4, order 5, and order 6) is compared with a similarity threshold. Assuming that the geographical location similarities between order 1 and both of order 2 and order 3 are greater than the similarity threshold, order 2 and order 3 are clustered into class cluster 1 corresponding to order 1. Therefore, class cluster 1 includes order 1, order 2, and order 3. Then, assuming that a reference order selected for the second time is order 6, and class cluster 2 is derived. A geographical location similarity between order 6 and each of other remaining orders (i.e., order 4 and order 5) is compared with a similarity threshold. Assuming that the geographical location similarity between order 4 and order 6 is greater than the similarity threshold, order 4 is clustered into class cluster 2 corresponding to order 6, so that class cluster 2 includes order 4 and order 6. Then, only order 5 is left, and order 5 forms class cluster 3.

In some embodiments, a historical order may first be selected from a plurality of historical orders as a reference order to derive a class cluster. Further, clustering process may be performed on unclustered orders based on a geographical location similarity between the unclustered orders in the plurality of historical orders and a historical order in the class cluster corresponding to the reference order. More Specifically, the clustering process is as follows. Each time one historical order is added to a class cluster, a next added historical order needs to meet the following condition: geographical location similarities between the next added historical order and all historical orders that have been added to the class cluster are greater than or equal to a similarity threshold.

For example, assuming that the plurality of historical orders include order 1, order 2, order 3, order 4, order 5, and order 6. A reference order selected for the first time is order 1, and class cluster 1 is derived. In this case, unclustered historical orders are order 2, order 3, order 4, order 5, and order 6. It is assumed that order 2 is randomly selected to determine whether order 2 can be added to class cluster 1. Assuming that a geographical location similarity between order 2 and order 1 is greater than a similarity threshold, then order 2 can be added to class cluster 1. In this case, remaining unclustered historical orders are updated to order 3, order 4, order 5, and order 6. Further, one order whose geographical location similarities with order 1 and order 2 are greater than the similarity threshold may be selected from the unclustered historical orders. Assuming that order 5 meets this condition, order 5 may be added to class cluster 1. In this case, assuming that none of remaining unclustered historical orders (i.e., order 3, order 4, and order 6) has geographical location similarities with all the historical orders added to class cluster 1 greater than a similarity threshold, then class cluster 1 will eventually include order 1, order 2, and order 5. Then, the foregoing clustering process may be repeatedly performed on the remaining historical orders until all the historical orders are clustered into a class cluster.

To obtain a better clustering effect, that is, to achieve high geographical location similarity between historical orders within a same class cluster, and a low geographical location similarity between historical orders in different class clusters, in actual application, the geographical location similarity is usually expressed as weighted results of a plurality of measurement parameters. In one embodiment, the weighting coefficient may be set to 1. The weighting coefficient of each measurement parameter may be empirically set. For example, the geographical location similarity may be expressed as a/A+b/B, where A is a distance between pickup locations, B is a distance between delivery locations, and the weighting coefficients are a and b, and a+b=1. In this case, the geographical location similarity between two historical orders is determined by a distance between pickup addresses and a distance between delivery addresses. Optionally, a corresponding similarity threshold may be set for each measurement parameter. For example, threshold 1 corresponding to the distance between pickup addresses and threshold 2 corresponding to the distance between delivery addresses may be set. In this case, a geographical location similarity between two historical orders may include similarity score 1 corresponding to the distance between pickup addresses and similarity score 2 corresponding to the distance between delivery addresses. Only when similarity score 1 is greater than threshold 1 and similarity score 2 is greater than threshold 2, the two historical orders are considered to be similar. Taking similarity score 1 as an example, a correspondence between similarity score 1 and the corresponding distance between pickup addresses may be preset. For example, the correspondence may be preset using a preset functional expression. That is, a function mapping relationship f(L) between the distance between pickup addresses and the similarity score may be preset, where L represents the distance between pickup addresses, and f represents the function mapping relationship.

In this embodiment, clustering process may be performed on the plurality of historical orders based on the geographical location similarities between the plurality of historical orders, and it is assumed that N class clusters may be obtained. Based on the clustering process, historical orders whose geographical locations are closer to each other are clustered into one class cluster. That is, historical orders whose geographical location similarities are greater than or equal to a preset similarity threshold are clustered into one class cluster.

In addition, assuming that based on the original delivery area, a historical order in the plurality of historical orders is a cross-area order (i.e., assuming that a pickup location and a delivery location of a historical order respectively correspond to different original delivery areas), then after the foregoing clustering process, the cross-area historical order may be clustered into a class cluster based on a geographical location similarity with another historical order. That is because there may exist some other cross-area historical orders that have same crossed delivery areas as the historical order in the plurality of historical orders. This also explains why the delivery area division method of this disclosure may also be considered as an optimization method for delivery area division. If there is a relatively large quantity of cross-area orders between two original delivery areas, division of the two original delivery areas may be improper.

In addition, if a class cluster includes a historical order across multiple original delivery areas, a coverage area of the class cluster may cover a pickup address and a delivery address of the historical order across multiple original delivery areas. Therefore, when delivery area division is performed on the class cluster, a newly obtained delivery area may cover both the pickup address and the delivery address of the historical order across multiple original delivery areas, so that the historical order across multiple original delivery areas is no longer a cross-area order in the newly divided delivery area. Therefore, the newly divided delivery area may greatly reduce the number of cross-area orders.

In step 102, based on a geographical location of a historical order included in each of the N class clusters, a coverage area corresponding to each of the N class clusters may be obtained.

After clustering process is performed on a plurality of historical orders to obtain N class clusters, the plurality of historical orders may be clustered into different class clusters. One historical order may be clustered into only one class cluster. Further, for each class cluster, optionally, a coverage area corresponding to the class cluster may be delimited on a preset map based on a geographical location corresponding to a historical order included in the class cluster, so that geographical locations corresponding to all historical orders in the class cluster may fall within the coverage area. The preset map may be a basic map used for dividing delivery areas of the foregoing city, and may include elements such as roads, preset names of some delivery areas, and merchant names. Optionally, the preset map may further display an identifier of an original delivery area corresponding to names of each delivery area.

When obtaining the N class clusters and determining a coverage area corresponding to each class cluster, identifiers for historical orders included in each class cluster may first be marked on the preset map. Then a coverage area of the class cluster may be delimited on the preset map.

Optionally, the identifier of the historical order may be a pattern of a certain shape, such as a dot, a square, or a small red flag, and may be used to identify a pickup address or a delivery address corresponding to the historical order. Therefore, each historical order may have two identifiers, one is used to identify a pickup address, and the other is used to identify a delivery address.

Optionally, a coverage area corresponding to each class cluster may be determined by using a convex hull algorithm. That is, the coverage area may be obtained by finding a smallest convex polygon that covers geographical locations corresponding to all historical orders in the class cluster. More specifically, a rectangular coordinate system may be established on the preset map in advance. For any class cluster, after identifiers of historical orders included in the class cluster are marked on the preset map, coordinates corresponding to identifiers of each historical order in the coordinate system may be obtained. Further, currently commonly used convex hull algorithms, such as Graham's scan method and Jarvis step method, may be used to determine coverage areas corresponding to various class clusters.

In step 103, based on the coverage area corresponding to each of the N class clusters, a delivery area corresponding to each of the N class clusters may be determined.

In this embodiment, if the foregoing plurality of historical orders have been sufficiently collected (e.g., a quantity of collected historical orders has reached a specific quantity threshold, and/or a quantity of collection days has reached a specific quantity threshold), optionally, for any class cluster in the N class clusters, the delivery area corresponding to the class cluster may be determined to be a coverage area corresponding to the class cluster. Alternatively, in some embodiments, the delivery area corresponding to a class cluster may be determined to be a union set of the coverage area corresponding to the class cluster and an original delivery area corresponding to the class cluster.

In the case that the delivery area corresponding to a class cluster is determined to be the union set of the coverage area corresponding to the class cluster and the original delivery area corresponding to the class cluster, the original delivery area corresponding to the class cluster needs to be first determined. More specifically, since the foregoing clustering process is based on the geographical location similarity, historical orders clustered into one class cluster are mostly historical orders corresponding to a same original delivery area. Therefore, an original delivery area corresponding to a class cluster may be determined based on original delivery areas corresponding to most historical orders in the class cluster.

The following specifically describes, compared with the original delivery area, the reduction of cross-area orders after the delivery area corresponding to a class cluster is determined to be the union set of the coverage area corresponding to the class cluster and the original delivery area corresponding to the class cluster.

For a cross-area historical order based on an original delivery area, the cross-area historical order is clustered into a class cluster based on a geographical location similarity with another historical order, and a coverage area of the class cluster includes a geographical location of the cross-area historical order (i.e., includes a pickup location and a delivery location of the cross-area historical order). Therefore, a delivery area delimited based on the coverage area of the class cluster also covers the geographical location of the cross-area historical order, and a new order corresponding to the geographical location of the cross-area historical order is no longer a cross-area order if received subsequently. Therefore, by continuously optimizing the division of the delivery areas based on the delivery area division method provided in this embodiment, the number of cross-area orders may be effectively reduced.

Based on the foregoing description, clustering process may be performed on a large quantity of historical orders based on geographical location similarities between the historical orders, and a delivery area of a class cluster may be determined based on a coverage area corresponding to the class cluster, thereby implementing automatic division of the delivery area. In addition, the division of the delivery areas may help to reduce the number of cross-area orders, thereby facilitating efficient utilization of the delivery capability.

FIG. 2 is a flowchart illustrating an implementation of step 102 in the embodiment shown in FIG. 1. As shown in FIG. 2, the implementation may include the following steps.

In step 201, based on the geographical location of the historical order included in each of the N class clusters, an order line segment corresponding to each of the N class clusters may be obtained. The order line segment may be in a one-to-one correspondence with the historical order, and end points of each order line segment may represent a pickup location and a delivery location of a corresponding historical order.

In step 202, a smallest closed polygon corresponding to each of the N class clusters may be obtained. The smallest closed polygon may enclose all order line segments of a corresponding class cluster, and the smallest closed polygon corresponding to each of the N class clusters may represent the coverage area corresponding to each of the N class clusters.

When obtaining the N class clusters and determining a coverage area corresponding to each class cluster, identifiers for historical order included in each class cluster may first be drawn on the preset map. Further, for any class cluster, refer to the description in the foregoing embodiment, a smallest closed polygon enclosing all order line segments corresponding to the class cluster may be determined using an algorithm such as a convex hull algorithm.

In some embodiments, the identifiers for the historical orders may be displayed in a form of an order line segment. In this case, one historical order may be corresponding to one order line segment, and two end points of an order line segment may respectively represent a pickup location and a delivery location of the historical order.

To clearly distinguish between order line segments corresponding to class clusters, and conveniently determine a coverage area corresponding to a class cluster subsequently, the order line segments corresponding to different class clusters may be drawn on the preset map using different drawing patterns. The drawing patterns may be different in color, line shape, or the like.

The order line segments corresponding to each of the N class clusters may be determined on the preset map by pinning a pickup address and a delivery address corresponding to each historical order on the preset map, so that distribution of order line segments of historical orders corresponding to the class clusters can be conveniently obtained. In some embodiments, the order line segments may be determined without resorting to the preset map. Optionally, one historical order may first be selected from a plurality of historical orders, and a pickup address or a delivery address of the historical order may be used as reference addresses to determine relative locations of a pickup address and a delivery address of each historical order relative to the reference addresses. Then the pickup address and the delivery address of each historical order may be connected to obtain an order line segment of each historical order.

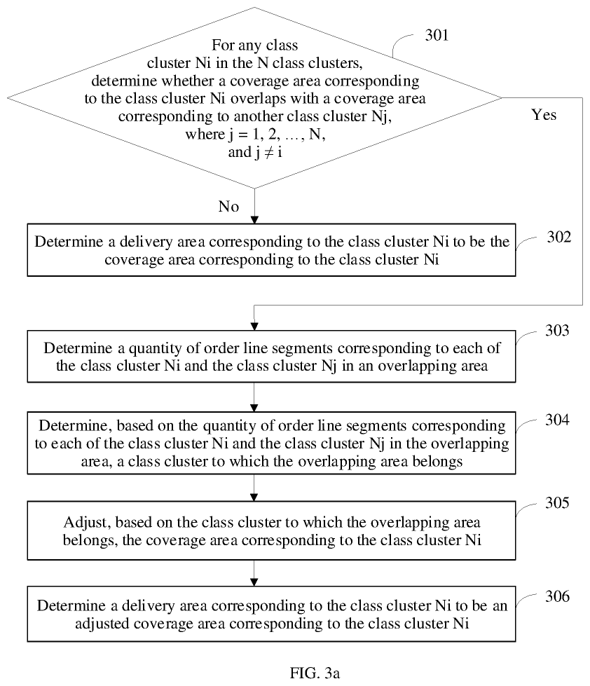

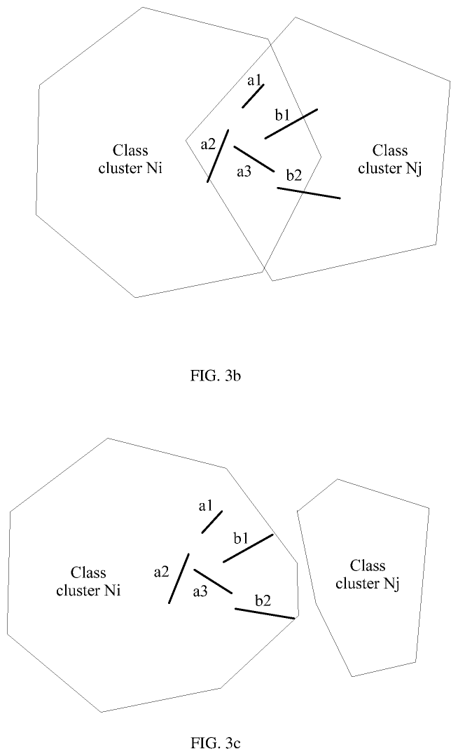

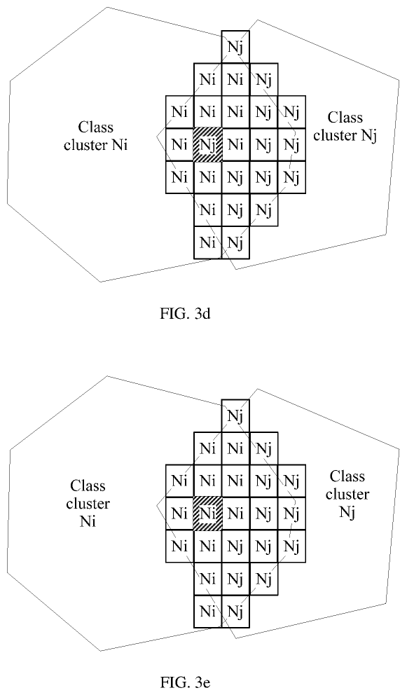

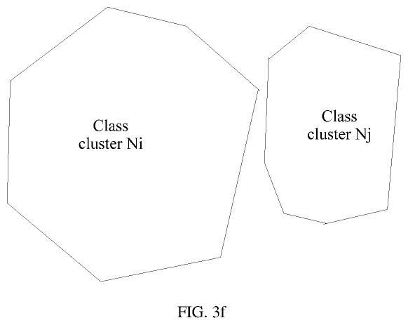

In actual application, after a coverage area corresponding to each class cluster is obtained based on a specific algorithm, in some embodiments, the obtained coverage areas may not necessarily be completely independent of each other (i.e., some coverage areas may overlap with each other). Referring FIG. 3a, the following describes the determination of a delivery area corresponding to each class cluster in this case.

FIG. 3a is a flowchart illustrating an implementation of step 103 in the embodiment shown in FIG. 1. As shown in FIG. 3a, the implementation may include the following steps.

In step 301, for any class cluster Ni in the N class clusters, whether a coverage area corresponding to the class cluster Ni overlaps with a coverage area corresponding to another class cluster Nj is determined, where j=1, 2, . . . , N, and j≠i. If there is no overlapping, step 302 is performed, otherwise, steps 303 to 306 are performed.

More specifically, coverage areas of any two class clusters may be determined to be overlapped if there exists at least one order line segment that has a pickup location in one of the two class clusters, and a delivery location in the other one of the two class clusters.

In step 302, a delivery area corresponding to the class cluster Ni is determined to be the coverage area corresponding to the class cluster Ni.

For any class cluster Ni, if there is no any other class cluster in the N class clusters whose coverage area overlaps with the coverage area of the class cluster Ni, optionally, the delivery area corresponding to the class cluster Ni may be determined to be the coverage area corresponding to the class cluster Ni.

In step 303, a quantity of order line segments corresponding to each of the class cluster Ni and the class cluster Nj in an overlapping area may be determined.

In step 304, based on the quantity of order line segments corresponding to each of the class cluster Ni and the class cluster Nj in the overlapping area, a class cluster to which the overlapping area belongs may be determined.

In step 305, based on the class cluster to which the overlapping area belongs, the coverage area corresponding to the class cluster Ni may be adjusted.

In step 306, a delivery area corresponding to the class cluster Ni may be determined to be an adjusted coverage area corresponding to the class cluster Ni.

For any class cluster Ni, if at least one class cluster Nj exists in the N class clusters that has a coverage area overlaps with a coverage area of the class cluster Ni, the coverage area of the class cluster Ni may be adjusted by determining a class cluster to which the overlapping area belongs. The coverage area of the class cluster Nj may be also correspondingly adjusted.

The class cluster to which the overlapping area belongs may be determined based on quantities of order line segments that are corresponding to the class cluster Ni and the class cluster Nj within the overlapping area. An order line segment corresponding to the class cluster Ni or the class cluster Nj may be determined to be within the overlapping area as long as a part of the order line segment falls within the overlapping area, and the order line segment does not need to be entirely located within the overlapping area.

For an order line segment that falls within the overlapping area, since the order line segment represents a historical order that has been clustered into class cluster Ni or class cluster Nj after the clustering process, a class cluster corresponding to the order line segment may be determined based on whether the historical order represented by the order line segment has been clustered into class cluster Ni or class cluster Nj. That is, in the overlapping area, an order line segment corresponding to the class cluster Ni is an order line segment that falls within the overlapping area and whose corresponding historical order is clustered into the class cluster Ni.

Assuming it is determined that in the overlapping area, the quantity of order line segments corresponding to the class cluster Ni is greater than the quantity of order line segments corresponding to the class cluster Nj, the overlapping area may be determined to belong to the class cluster Ni. In this case, the coverage area of the class cluster Ni may be expanded, and the coverage area of the class cluster Nj may be shrink because the overlapping area is removed. On the contrary, assuming it is determined that in the overlapping area, the quantity of order line segments corresponding to the class cluster Ni is less than the quantity of order line segments corresponding to the class cluster Nj, the overlapping area may be determined to belong to the class cluster Nj. In this case, the coverage area of the class cluster Ni may be shrink because the overlapping area is removed, and the coverage area of the class cluster Nj may be expanded.

The expansion of the coverage area of the class cluster Ni and the shrinkage of the coverage area of the class cluster Nj is used an example to describe an optional determining manner of the coverage areas of the class cluster Ni and the class cluster Nj. Determining that the overlapping area belongs to the class cluster Ni is equivalent to classifying the historical orders corresponding to order line segments in the overlapping area into the class cluster Ni. In this case, historical orders included in the class cluster Ni and the class cluster Nj may be updated. That is, the historical orders corresponding to the order line segments in the overlapping area may be added to the class cluster Ni, and correspondingly, the historical orders corresponding to the order line segments in the overlapping area may be removed from the class cluster Nj. Therefore, the coverage area of the class cluster Ni and the coverage area of the class cluster Nj may be adjusted based on geographical locations of updated historical orders in the class cluster Ni and the class cluster Nj.

Referring to FIG. 3b, in the overlapping area between the class cluster Ni and the class cluster Nj, it is assumed that order line segments a1, a2, and a3 are order line segments corresponding to the class cluster Ni, and order line segments b1 and b2 are order line segments corresponding to the class cluster Nj. Therefore, since the quantity of order line segments corresponding to the class cluster Ni in the overlapping area is greater than the quantity of order line segments corresponding to the class cluster Nj, the overlapping area is determined to belong to the class cluster Ni, and the coverage areas may be adjusted, as shown in FIG. 3c.

In the aforementioned description, the ownership of the overlapping area is determined by considering the overlapping area as a whole. However, in actual application, the coverage area of the class cluster Ni and the coverage area of the class cluster Nj may overlap with each other, and the overlapping area may have more order line segments corresponding to the class cluster Ni in areas closer to the class cluster Ni, and more order line segments corresponding to the class cluster Nj in areas closer to the class cluster Nj. For an order line segment in the overlapping area between the class cluster Ni and the class cluster Nj, being closer to the class cluster Ni means that a distance from a coverage area boundary of the class cluster Ni is greater than a distance from a coverage area boundary of the class cluster Nj. In this case, to more accurately determine the ownership of the overlapping area, the overlapping area may analyzed at a smaller grid.

That is, the ownership of the overlapping area may be determined by using the overlapping area as a whole, as described above. Alternatively, the overlapping area may be divided into a plurality of sub-areas, and the ownership of the overlapping area may be determined by determining ownerships of the plurality of sub-areas.

Taking the coverage area of the class cluster Ni and the coverage area of the class cluster Nj as an example, grid division may be first performed on the overlapping area to obtain M grids, as shown in FIG. 3d. The shape and the size of the grid may be set based on an actual requirement. It should be noted that grid division on the overlapping area may be directly implemented by performing grid division on the overlapping area, or may be indirectly implemented by performing grid division on an entire coverage area of all the N class clusters. Further, for each of the M grids, a quantity of order line segments corresponding to each of the class cluster Ni and the class cluster Nj in each grid may be determined, so as to determine, based on the quantity of order line segments corresponding to each of the class cluster Ni and the class cluster Nj in each grid, a class cluster to which each of the M grids belongs. Relevant parts in the foregoing description may be referred to for a process of determining the class cluster to which each grid belongs, details of which are not repeatedly described herein. As shown in FIG. 3d, it is assumed that each grid belongs to one of the class cluster Ni and the class cluster Nj. A word Ni in a grid indicates that this grid belongs to the class cluster Ni, and a word Nj in a grid indicates that this grid belongs to the class cluster Nj.

However, it should be noted that for any order line segment falling within the overlapping area between the class cluster Ni and the class cluster Nj, the order line segment may fall within a plurality of grids. That is, the order line segment may cross a plurality of grids. For example, an order line segment corresponding to the class cluster Ni may cross grid 1 and grid 2. In this case, when determining a quantity of order line segments corresponding to the class cluster Ni in grid 1, this order line segment is counted as one order line segment corresponding to the class cluster Ni in grid 1, and when determining a quantity of order line segments corresponding to the class cluster Ni in grid 2, this order line segment is also counted as one order line segment corresponding to the class cluster Ni in grid 2.

In one scenario, as shown in FIG. 3d, after the class cluster to which each of the M grids belongs is determined, one grid in the M grids may be determined to belong to a class cluster that is different from the class clusters to which other grids around the grid belong. In this case, the class cluster to which the grid belongs may need to be adjusted.

Therefore, for any grid Mk in the M grids, whether the grid Mk is an abnormal grid may be determined based on the location of the grid Mk in the overlapping area and class clusters to which a plurality of adjacent grids of the grid Mk belong. If the grid Mk determined to be an abnormal grid, the class cluster to which the grid Mk belongs may be adjusted based on the class clusters to which the plurality of adjacent grids of the grid Mk belong. As shown in FIG. 3d, the shaded grid is initially determined to belongs to the class cluster Nj. Because most grids around the grid (particularly, grids that located closer to the class cluster Nj than the grid) belong to the class cluster Ni, the grid is determined to be an abnormal grid and the class cluster to which the grid belongs needs to be adjusted to class cluster Ni, as shown in FIG. 3e. A possible reason for this phenomenon is that order line segments corresponding to the class cluster Nj in the overlapping area may be concentratedly distributed in one grid, and order line segments corresponding to the class cluster Ni may be evenly distributed in adjacent grids around the grid.

Finally, the coverage area corresponding to the class cluster Ni may be adjusted based on the class clusters to which the M grids belong. More specifically, a grid corresponding to the class cluster Ni in the overlapping area may be added into the coverage area of the class cluster Ni, and a grid corresponding to the class cluster Nj in the overlapping area may be added into the coverage area of the class cluster Nj, as shown in FIG. 3f. Then, the delivery area corresponding to the class cluster Ni may be determined to be the adjusted coverage area corresponding to the class cluster Ni.

In the foregoing embodiment, after clustering process is performed on the plurality of historical orders based on the geographical location similarity to obtain the N class clusters, coverage areas of different class clusters may overlap with each other. By accurately determining the class cluster to which the overlapping area belongs, the coverage areas of the class clusters may be properly adjusted, and delivery areas may be determined based on adjusted coverage areas of the class clusters.

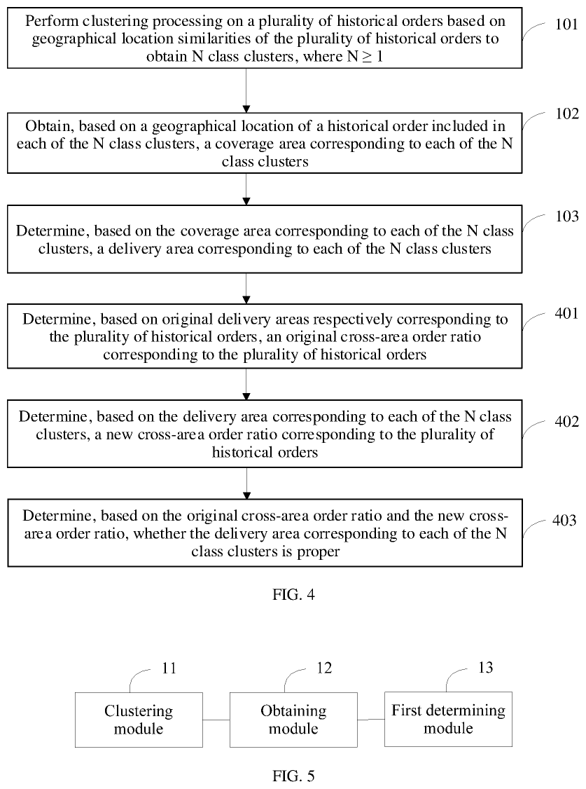

FIG. 4 is a flowchart illustrating Embodiment 2 of a delivery area division method of this disclosure. As shown in FIG. 4, based on the foregoing embodiments, for example, the embodiment shown in FIG. 1, the method may further include the following steps after step 103.

In step 401, based on original delivery areas respectively corresponding to the plurality of historical orders, an original cross-area order ratio corresponding to the plurality of historical orders may be determined.

In step 402, based on the delivery area corresponding to each of the N class clusters, a new cross-area order ratio corresponding to the plurality of historical orders may be determined.

In step 403, based on the original cross-area order ratio and the new cross-area order ratio, whether the delivery area corresponding to each of the N class clusters is proper may be determined.

After the delivery area corresponding to each of the N class clusters is obtained based on the foregoing embodiments, it may be further verified whether delivery area division corresponding to each of the N class clusters is proper. Optionally, since improper delivery area division may lead to a large quantity of cross-area orders, whether delivery area division corresponding to the N class clusters are proper may be verified based on whether the number of the cross-area orders are reduced.

More specifically, for any historical order in the plurality of historical orders, whether the order is a cross-area order may be determined based on whether a pickup location and a delivery location of the order are located in a same original delivery area. Therefore, in the original delivery area, the original cross-area order ratio corresponding to the plurality of historical orders may be determined based on a ratio of a quantity of cross-area orders in the plurality of historical orders to a total quantity of the plurality of historical orders. In addition, because a historical order has been clustered into a specific class cluster after clustering process, whether the historical order is currently a cross-area order may be determined based on whether a pickup location and a delivery location of the historical order are located in a delivery area corresponding to the class cluster to which the historical order is clustered. Therefore, in a delivery area corresponding to each of N newly divided class clusters, a new cross-area order ratio corresponding to the plurality of historical orders may be determined based on a ratio of a quantity of cross-area orders in the plurality of historical orders to the total quantity of the plurality of historical orders. If the original cross-area order ratio is greater than the new cross-area order ratio, the determination of the delivery areas corresponding to the N newly determined class clusters are considered to be proper. Otherwise, the determination of the delivery areas corresponding to the N newly determined class clusters are considered to be improper. If the delivery areas are improper, the delivery areas may be replaced by corresponding original delivery areas. That is, the original delivery area will not be modified.

Delivery area division apparatuses in one or more embodiments of this disclosure are described in detail below. Persons skilled in the art may understand that all these delivery area division apparatuses may be constituted by configuring, according to the steps in this solution, hardware components sold in the market.

FIG. 5 is a schematic structural diagram illustrating Embodiment 1 of a delivery area division apparatus of this disclosure. As shown in FIG. 5, the apparatus may include a clustering module 11, an obtaining module 12, and a first determining module 13.

The clustering module 11 may be configured to perform clustering process on a plurality of historical orders based on similarities between geographical locations of the plurality of historical orders to obtain N class clusters, where N≥1.

The obtaining module 12 may be configured to obtain, based on the geographical location of each of one or more historical orders included in each of the N class clusters, a coverage area corresponding to each of the N class clusters.

The first determining module 13 may be configured to determine, based on the coverage area corresponding to each of the N class clusters, a delivery area corresponding to each of the N class clusters.

The geographical location may include a pickup location and a delivery location, and the similarity between the geographical locations may be measured by at least one of the following parameters: a distance between pickup locations, a distance between delivery locations, and a distance between a center point of the pickup locations and a center point of the delivery locations.

The apparatus shown in FIG. 5 can perform the method in the embodiment shown in FIG. 1. Relevant description in the embodiment shown in FIG. 1 may be referred to for the part not described in detail in this embodiment, and for the implementation process and technical effects of the technical solution, the details of which are not repeatedly described herein for the sake of conciseness.

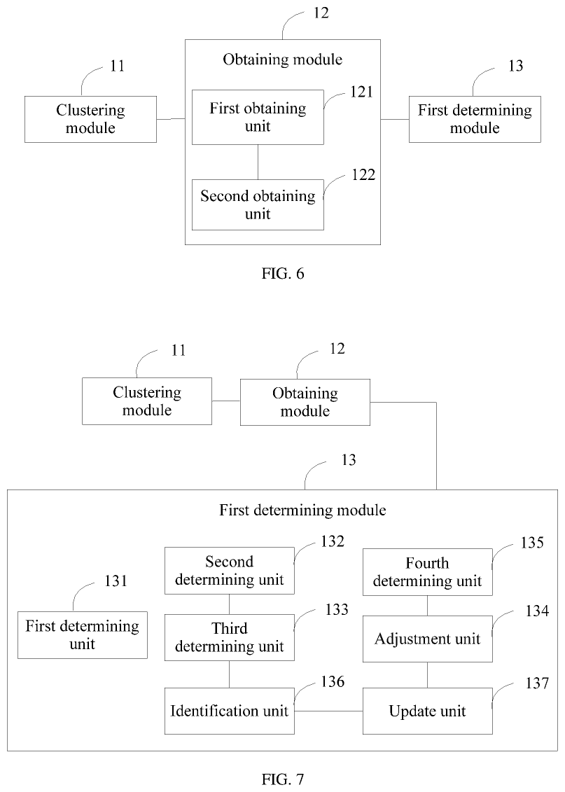

FIG. 6 is a schematic structural diagram illustrating Embodiment 2 of a delivery area division apparatus of this disclosure. As shown in FIG. 6, based on the embodiment shown in FIG. 5, the obtaining module 12 may include a first obtaining unit 121 and a second obtaining unit 122.

The first obtaining unit 121 may be configured to obtain, based on the geographical location of each of the one or more historical orders included in each of the N class clusters, one or more order line segments corresponding to each of the N class clusters. Each of the one or more order line segments is in a one-to-one correspondence with the one or more historical orders, and end points of each order line segment correspond to a pickup location and a delivery location of a corresponding historical order.

The second obtaining unit 122 may be configured to obtain a smallest closed polygon corresponding to each of the N class clusters. The smallest closed polygon encloses all order line segments of a corresponding class cluster, and the smallest closed polygon corresponding to each of the N class clusters represents the coverage area corresponding to each of the N class clusters.

The apparatus shown in FIG. 6 may perform the method in the embodiment shown in FIG. 2. Relevant description in the embodiment shown in FIG. 2 may be referred to for the part not described in detail in this embodiment, and for the implementation process and technical effects of the technical solution, details of which are not repeatedly described herein for the sake of conciseness.

FIG. 7 is a schematic structural diagram illustrating Embodiment 3 of a delivery area division apparatus of this disclosure. As shown in FIG. 7, based on the foregoing embodiment, the first determining module 13 may include a first determining unit 131, a second determining unit 132, a third determining unit 133, an adjustment unit 134, and a fourth determining unit 135.

In one example, the first determining unit 131 may be configured to: for any class cluster Ni in the N class clusters, determine a delivery area corresponding to the class cluster Ni to be the coverage area corresponding to the class cluster Ni if the coverage area corresponding to the class cluster Ni does not overlap with the coverage area corresponding to another class cluster Nj, where j=1, 2, . . . , N, and j≠i.

In another example, the second determining unit 132 may be configured to: for any class cluster Ni in the N class clusters, determine a quantity of order line segments corresponding to each of the class cluster Ni and the class cluster Nj in an overlapping area between the class cluster Ni and the class cluster Nj if the coverage area corresponding to the class cluster Ni overlaps with the coverage area corresponding to another class cluster Nj, where j=1, 2, . . . , N, and j≠i. The third determining unit 133 may be configured to determine, based on the quantity of order line segments, a class cluster to which the overlapping area belongs. The adjustment unit 134 may be configured to adjust, based on the class cluster to which the overlapping area belongs, the coverage area corresponding to the class cluster Ni. The fourth determining unit 135 may be configured to determine a delivery area corresponding to the class cluster Ni to be the adjusted coverage area corresponding to the class cluster Ni.

In some embodiments, the second determining unit 132 may be configured to perform grid division on the overlapping area to obtain M grids, and determine a quantity of order line segments corresponding to each of the class cluster Ni and the class cluster Nj in each of the M grids.

Correspondingly, the third determining unit 133 may be configured to determine, based on the quantity of order line segments corresponding to each of the class cluster Ni and the class cluster Nj in each of the M grids, a class cluster to which each of the M grids belongs.

Correspondingly, the adjustment unit 134 may be configured to adjust, based on the class cluster to which each of the M grids belongs, the coverage area corresponding to the class cluster Ni.

In some embodiments, the first determining module 13 may further include an identification unit 136 and an update unit 137.

The identification unit 136 may be configured to: for any grid Mk in the M grids, identify, based on a location of the grid Mk in the overlapping area and class clusters to which a plurality of adjacent grids of the grid Mk belong, whether the grid Mk is an abnormal grid.

The update unit 137 may be configured to: if the grid Mk is determined to be an abnormal grid, update, based on the class clusters to which the plurality of adjacent grids belong, a class cluster to which the grid Mk belongs.

The apparatus shown in FIG. 7 may perform the method in the embodiment shown in FIG. 3a. Relevant description in the embodiment shown in FIG. 3a may be referred to for the part not described in detail in this embodiment, and for the implementation process and technical effects of the technical solution, details of which are not repeatedly described herein for the sake of conciseness.

FIG. 8 is a schematic structural diagram illustrating Embodiment 4 of a delivery area division apparatus of this disclosure. As shown in FIG. 8, based on the embodiment shown in FIG. 5, the apparatus may further include a second determining module 21, a third determining module 22, and a fourth determining module 23.

The second determining module 21 may be configured to: determine, based on the original delivery areas respectively corresponding to the plurality of historical orders, an original cross-area order ratio corresponding to the plurality of historical orders.

The third determining module 22 may be configured to: determine, based on the delivery area corresponding to each of the N class clusters, a new cross-area order ratio corresponding to the plurality of historical orders.

The fourth determining module 23 may be configured to: determine, based on the original cross-area order ratio and the new cross-area order ratio, whether the delivery area corresponding to each of the N class clusters is proper.

The apparatus shown in FIG. 8 may perform the method in the embodiment shown in FIG. 4. Relevant description in the embodiment shown in FIG. 4 may be referred to for the part not described in detail in this embodiment, and for the implementation process and technical effects of the technical solution, details of which are not repeatedly described herein for the sake of conciseness.

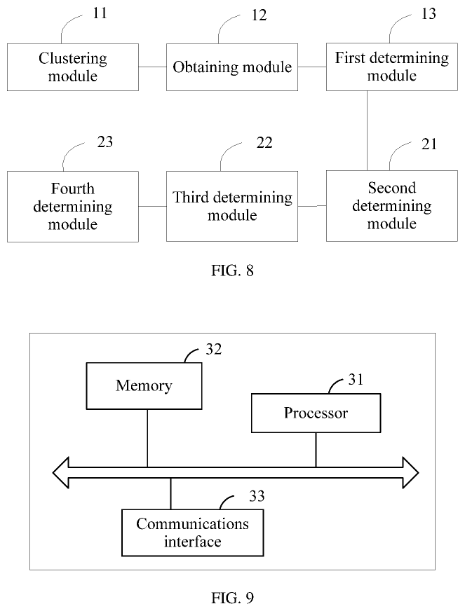

The foregoing describes internal functions and structures of the delivery area division apparatus. In a possible design, a structure of the delivery area division apparatus may be implemented as an electronic device. The electronic device may be, for example, a server. As shown in FIG. 9, the electronic device may include a processor 31 and a memory 32. The memory 32 may be configured to store a program that supports the delivery area division apparatus in performing the delivery area division method according to any of the foregoing embodiments, and the processor 31 may be configured to execute the program stored in the memory 32.

The program may include one or more computer instructions that are executable by the processor 31.

The processor 31 may be configured to perform clustering process on a plurality of historical orders based on similarities between geographical locations of the plurality of historical orders to obtain N class clusters, where N≥1; obtain, based on the geographical location of each of one or more historical orders included in each of the N class clusters, a coverage area corresponding to each of the N class clusters; and determine, based on the coverage area corresponding to each of the N class clusters, a delivery area corresponding to each of the N class clusters.

In some embodiments, the processor 31 may be further configured to perform all or some of the steps of the methods.

The structure of the delivery area division apparatus may further include a communications interface 33, configured to communicate with another device or a communications network by the delivery area division apparatus.

This disclosure further provides a computer-readable storage medium, configured to store a computer software instruction used by a delivery area division apparatus. The computer software instruction may include a program used to perform the delivery area division method in the foregoing method embodiments.

The apparatus embodiments described above are merely examples. The units described as discrete parts may be physically separated or not, and parts displayed as units may be physical units or not, may be located in one place or distributed on a plurality of network units. Some or all of the modules may be selected according to actual needs to achieve the objectives of the solution of this embodiment. A person of ordinary skill in the art can understand and implement the solution without creative efforts.

Based on the foregoing descriptions of the implementations, a person skilled in the art may clearly understand that the implementations may be implemented by software in addition to a necessary universal hardware platform or by hardware certainly. Based on such an understanding, the technical solutions essentially or the part contributing to the prior art may be implemented in a form of a product. The computer product may be stored in a computer-readable storage medium, such as a ROM/RAM, a disk, or an optical disc, and includes several instructions for instructing a computer apparatus (which may be a personal computer, a server, or a network apparatus) to perform the methods described in the embodiments or some parts of the embodiments.

Finally, it should be noted that the foregoing embodiments are merely intended for describing but not limiting the technical solutions of this disclosure. Although this disclosure is described in detail with reference to the foregoing embodiments, persons of ordinary skill in the art should understand that they may still make modifications to the technical solutions described in the foregoing embodiments or make equivalent replacements to some technical features thereof, and such modifications and replacements do not cause the essence of the corresponding technical solutions to depart from the spirit or scope of the technical solutions of the embodiments of this disclosure.

What is claimed is:

1. A delivery area division method, comprising:
performing, based on similarities between geographical locations of a plurality of historical orders, clustering process on the plurality of historical orders to obtain N class clusters, wherein N≥1, and the geographical location comprises a pickup location and a delivery location;
obtaining, based on the geographical location of each of one or more historical orders included in each of the N class clusters, a coverage area corresponding to each of the N class clusters;
determining, based on the coverage area corresponding to each of the N class clusters, a delivery area corresponding to each of the N class clusters; and
determining, based on an original cross-area order ratio and a new cross-area order ratio, whether the delivery area corresponding to each of the N class clusters is proper, and, in response to the delivery area corresponding to one of the N class clusters being determined to be improper, replacing the delivery area by an original delivery area corresponding to the one of the N class cluster,
wherein the original cross-area order ratio is determined based on original delivery areas respectively corresponding to the plurality of historical orders, the new cross-area order ratio is determined based on the delivery area corresponding to each of the N class clusters,
wherein determining, based on the coverage area corresponding to each of the N class clusters, a delivery area corresponding to each of the N class clusters comprises:
for any class cluster Ni in the N class clusters, if the coverage area corresponding to the class cluster Ni overlaps with the coverage area corresponding to another class cluster Nj, determining a quantity of order line segments corresponding to each of the class cluster Ni and the class cluster Nj in an overlapping area between the class cluster Ni and the class cluster Nj, wherein j=1, 2, . . . , N, and j≠i;
obtaining an adjusted coverage area corresponding to the class cluster Ni by allocating the overlapping area between the class cluster Ni and the class cluster Nj to the class cluster that has the largest quantity of order line segments in the overlapping area; and
determining the delivery area corresponding to the class cluster Ni to be the adjusted coverage area corresponding to the class cluster Ni.

2. The method of claim 1, wherein the geographical location comprises a pickup location and a delivery location, and the similarity between the geographical locations is measured based on at least one of the following parameters: a distance between pickup locations, a distance between delivery locations, and a distance between a center point of the pickup locations and a center point of the delivery locations.

3. The method of claim 2, wherein obtaining, based on the geographical location of each of one or more historical orders in each of the N class clusters, a coverage area corresponding to each of the N class clusters comprises:
obtaining, based on the geographical location of each of the one or more historical orders in each of the N class clusters, one or more order line segments corresponding to each of the N class clusters, wherein each of the one or more order line segments is in a one-to-one correspondence with each of the one or more historical orders, and end points of each order line segment correspond to a pickup location and a delivery location of a corresponding historical order; and
obtaining a smallest closed polygon corresponding to each of the N class clusters, wherein the smallest closed polygon encloses all order line segments of a corresponding class cluster, and the smallest closed polygon corresponding to each of the N class clusters represents the coverage area corresponding to each of the N class clusters.

4. The method of claim 1, wherein determining, based on the coverage area corresponding to each of the N class clusters, a delivery area corresponding to each of the N class clusters comprises:
for any class cluster Ni in the N class clusters, if the coverage area corresponding to the class cluster Ni does not overlap with the coverage area corresponding to another class cluster Nj, determining the delivery area corresponding to the class cluster Ni to be the coverage area corresponding to the class cluster Ni, wherein j=1, 2, . . . , N, and j≠i.

5. The method of claim 1, wherein the determining, based on the coverage area corresponding to each of the N class clusters, a delivery area corresponding to each of the N class clusters comprises:
for any class cluster Ni in the N class clusters, if the coverage area corresponding to the class cluster Ni overlaps with the coverage area corresponding to another class cluster Nj, determining a quantity of order line segments corresponding to each of the class cluster Ni and the class cluster Nj in an overlapping area between the class cluster Ni and the class cluster Nj, wherein j=1, 2, . . . , N, and j≠i;
determining, based on the quantities of order line segments, a class cluster to which the overlapping area belongs;
adjusting, based on the class cluster to which the overlapping area belongs, the coverage area corresponding to the class cluster Ni; and
determining a delivery area corresponding to the class cluster Ni to be an adjusted coverage area corresponding to the class cluster Ni.

6. The method of claim 5, wherein determining a quantity of order line segments corresponding to each of the class cluster Ni and the class cluster Nj in an overlapping area between the class cluster Ni and the class cluster Nj comprises:
performing grid division on the overlapping area to obtain M grids; and
determining, in each of the M grids, a quantity of order line segments corresponding to each of the class cluster Ni and the class cluster Nj,
wherein determining, based on the quantities of order line segments, a class cluster to which the overlapping area belongs comprises:
determining, based on the quantity of order line segments corresponding to each of the class cluster Ni and the class cluster Nj in each of the M grids, a class cluster to which each of the M grids belongs,
and wherein adjusting, based on the class cluster to which the overlapping area belongs, the coverage area corresponding to the class cluster Ni comprises:
adjusting, based on the class cluster to which each of the M grids belongs, the coverage area corresponding to the class cluster Ni.

7. The method of claim 6, further comprising: after the determining, based on the quantity of order line segments corresponding to each of the class cluster Ni and the class cluster Nj in each of the M grids, a class cluster to which each of the M grids belongs,
for any grid Mk in the M grids, identifying, based on a location of the grid Mk in the overlapping area and class clusters to which a plurality of adjacent grids of the grid Mk belong, whether the grid Mk is an abnormal grid; and
if the grid Mk is determined to be an abnormal grid, updating, based on the class clusters to which the plurality of adjacent grids belong, a class cluster to which the grid Mk belongs.

8. The method of claim 1, further comprising:
determining, based on the original delivery areas respectively corresponding to the plurality of historical orders, the original cross-area order ratio corresponding to the plurality of historical orders;
determining, based on the delivery area corresponding to each of the N class clusters, the new cross-area order ratio corresponding to the plurality of historical orders; and
determining, based on the original cross-area order ratio and the new cross-area order ratio, whether the delivery area corresponding to each of the N class clusters is proper.

9. A delivery area division apparatus, comprising:
a clustering module, configured to perform, based on similarities between geographical locations of a plurality of historical orders, clustering process on the plurality of historical orders to obtain N class clusters, wherein N≥1, and the geographical location comprises a pickup location and a delivery location;
an obtaining module, configured to obtain, based on the geographical location of each of one or more historical orders included in each of the N class clusters, a coverage area corresponding to each of the N class clusters; and
a first determining module, configured to determine, based on the coverage area corresponding to each of the N class clusters, a delivery area corresponding to each of the N class clusters, and determine, based on an original cross-area order ratio and a new cross-area order ratio, whether the delivery area corresponding to each of the N class clusters is proper, and, in response to the delivery area corresponding to one of the N class clusters being determined to be improper, replace the delivery area by an original delivery area corresponding to the one of the N class cluster,
wherein the original cross-area order ratio is determined based on original delivery areas respectively corresponding to the plurality of historical orders, the new cross-area order ratio is determined based on the delivery area corresponding to each of the N class clusters,
wherein determining, based on the coverage area corresponding to each of the N class clusters, a delivery area corresponding to each of the N class clusters comprises:
for any class cluster Ni in the N class clusters, if the coverage area corresponding to the class cluster Ni overlaps with the coverage area corresponding to another class cluster Nj, determining a quantity of order line segments corresponding to each of the class cluster Ni and the class cluster Nj in an overlapping area between the class cluster Ni and the class cluster Nj, wherein j=1, 2, . . . , N, and j≠i;
obtaining an adjusted coverage area corresponding to the class cluster Ni by allocating the overlapping area between the class cluster Ni and the class cluster Nj to the class cluster that has the largest quantity of order line segments in the overlapping area; and
determining the delivery area corresponding to the class cluster Ni to be the adjusted coverage area corresponding to the class cluster Ni.

10. The apparatus of claim 9, wherein the geographical location comprises a pickup location and a delivery location, and the similarity between geographical locations is measured based on at least one of the following parameters: a distance between pickup locations, a distance between delivery locations, and a distance between a center point of the pickup locations and a center point of the delivery locations.

11. The apparatus of claim 10, wherein the obtaining module comprises:
a first obtaining unit, configured to obtain, based on the geographical location of each of the one or more historical orders in each of the N class clusters, one or more order line segments corresponding to each of the N class clusters, wherein each of the one or more order line segments is in a one-to-one correspondence with each of the one or more historical orders, and end points of each order line segment correspond to a pickup location and a delivery location of a corresponding historical order; and
a second obtaining unit, configured to obtain a smallest closed polygon corresponding to each of the N class clusters, wherein the smallest closed polygon encloses all order line segments of a corresponding class cluster, and the smallest closed polygon corresponding to each of the N class clusters represents the coverage area corresponding to each of the N class clusters.

12. The apparatus of claim 9, wherein the first determining module comprises:
a first determining unit, configured to: for any class cluster Ni in the N class clusters, determine the delivery area corresponding to the class cluster Ni to be the coverage area corresponding to the class cluster Ni if the coverage area corresponding to the class cluster Ni does not overlap with the coverage area corresponding to another class cluster Nj, wherein j=1, 2, . . . , N, and j≠i.

13. The apparatus of claim 9, wherein the first determining module comprises:
a second determining unit, configured to: for any class cluster Ni in the N class clusters, determine a quantity of order line segments corresponding to each of the class cluster Ni and the class cluster Nj in an overlapping area between the class cluster Ni and the class cluster Nj if the coverage area corresponding to the class cluster Ni overlaps with the coverage area corresponding to another class cluster Nj, wherein j=1, 2, . . . , N, and j≠i;
a third determining unit, configured to determine, based on the quantities of order line segments, a class cluster to which the overlapping area belongs;
an adjustment unit, configured to adjust, based on the class cluster to which the overlapping area belongs, the coverage area corresponding to the class cluster Ni; and
a fourth determining unit, configured to determine a delivery area corresponding to the class cluster Ni to be an adjusted coverage area corresponding to the class cluster Ni.

14. The apparatus of claim 13, wherein the second determining unit is configured to:
perform grid division on the overlapping area to obtain M grids; and
determine, in each of the M grids, a quantity of order line segments corresponding to each of the class cluster Ni and the class cluster Nj,
wherein the third determining unit is configured to:
determine, based on the quantity of order line segments corresponding to each of the class cluster Ni and the class cluster Nj in each of the M grids, a class cluster to which each of the M grids belongs,
and wherein the adjustment unit is configured to:
adjust, based on the class cluster to which each of the M grids belongs, the coverage area corresponding to the class cluster Ni.

15. The apparatus of claim 14, wherein the first determining module further comprises:
an identification unit, configured to: for any grid Mk in the M grids, identify, based on a location of the grid Mk in the overlapping area and class clusters to which a plurality of adjacent grids of the grid Mk belong, whether the grid Mk is an abnormal grid; and
an update unit, configured to: if the grid Mk is determined to be an abnormal grid, update, based on the class clusters to which the plurality of adjacent grids belong, a class cluster to which the grid Mk belongs.

16. The apparatus of claim 9, further comprising:
a second determining module, configured to: determine, based on the original delivery areas respectively corresponding to the plurality of historical orders, the original cross-area order ratio corresponding to the plurality of historical orders;
a third determining module, configured to: determine, based on the delivery area corresponding to each of the N class clusters, a new cross-area order ratio corresponding to the plurality of historical orders; and
a fourth determining module, configured to: determine, based on the original cross-area order ratio and the new cross-area order ratio, whether the delivery area corresponding to each of the N class clusters is proper.

17. An electronic device, comprising a memory and a processor, wherein the memory is configured to store one or more computer instructions, and, upon being executed by the processor, the one or more computer instructions perform the delivery area division method of claim 1.

18. A computer-readable storage medium storing a computer program, wherein, upon be executed, the computer program causes a computer to perform the delivery area division method of claim 1.
